(19) United States
(12) Patent Application Publication
(10) Pub. No.: US 2015/0235058 A1
(43) Pub. Date: Aug. 20, 2015

(54) ELECTRONIC APPARATUS AND PROTECTING METHOD THEREOF

(71) Applicant: Samsung Electronics Co., Ltd., Gyeonggi-do (KR)

(72) Inventor: Ki Youn Kim, Seoul (KR)

(21) Appl. No.: 14/583,071

(22) Filed: Dec. 24, 2014

(30) Foreign Application Priority Data
Feb. 20, 2014 (KR) 10-2014-0019719

(51) Int. Cl. G06F 21/88; G06F 21/81

(52) U.S. Cl. CPC G06F 21/88; G06F 21/81

(57) ABSTRACT

An electronic apparatus includes an auxiliary memory storing one of security level values that represent a protection or lost state, an auxiliary battery activated to supply a power when a main battery is separated without performing an ending process in the state where the security level value is in the protection or lost state, and a control unit controlling the electronic apparatus to change the security level value into the lost state, thereby allowing the electronic apparatus to operate in a lost mode, when the main battery is separated without performing the ending process in the state where the security level value is in the protection state.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Feb. 20, 2014 and assigned Serial No. 10-2014-0019719, the entire disclosure of which is hereby incorporated by reference.

### TECHNICAL FIELD

The present disclosure relates to an electronic device that is capable of strengthening security and a protecting method thereof.

### BACKGROUND

In recent years, various kinds of portable electronic devices are being developed with the developing of electronic technologies. Examples of representative portable electronic devices include mobile phones. Portable electronic devices such as smartphones are popularly propagated to such an extent that almost everyone has a portable electronic device due to portability and usability.

Mobile phones developed in the past are limited in function such as short message service (SMS). However, portable electronic devices such as smart phones, tablet PCs, and the like, which have been developed in recent years, have various functions. For example, smartphones provide various functions such as Web surfing, mail, game, messaging service, watching digital multimedia broadcasting (DMB), listening to music, movie appreciation, and the like through application in addition to calling or SMS service.

As portable electronic devices provide various functions, their manufacturing costs increase. As a result, smartphones having a price greater than that of desktop PCs are being released. Also, many incidents of loss of the more expensive portable electronic devices are gradually increasing.

### SUMMARY

Although services for recovering lost terminals (also referred to as portable electronic devices) are provided, there are limitations that the services are controlled by using applications and operate through a network. Also, if a lost terminal is not registered in advance by a user, the services for recovering are not provided to the user. Also, if a battery of the lost terminal is separated, and new binary is downloaded to the lost terminal, such that it may be difficult to recover the lost terminal. This lost terminal may be illegally distributed to the market as a used terminal.

To address the above-discussed deficiencies, it is a primary object to provide an electronic device of which a security operation is performed by itself to protect the electronic device and prevent new binary from being downloaded even though the electronic device is not connected to a network, or a battery of the electronic device is forcibly separated, and a method for protecting the electronic device.

In certain embodiments of the present disclosure, an electronic device includes: an auxiliary memory storing one of security level values that represent a protection or lost state; an auxiliary battery activated to supply a power when a main battery is separated without performing an ending process in the state where the security level value is in the protection or lost state; and a control unit controlling the electronic device to change the security level value into the lost state, thereby allowing the electronic device to operate in a lost mode, when the main battery is separated without performing the ending process in the state where the security level value is in the protection state.

In certain embodiments of the present disclosure, an electronic device includes: an auxiliary memory storing one of security level values that represent a protection or lost state; an auxiliary battery activated to supply a power when a main battery is separated without performing an ending process in the state where the security level value is in the protection or lost state; and a control unit controlling the electronic device to change the security level value into the lost state, thereby allowing the electronic device to operate in a lost mode, when it is detected that an input/output interface is connected without performing the ending process in the state where the security level value is in the protection state.

In certain embodiments of the present disclosure, a method for protecting an electronic device includes: storing a security level value that represents a protection state in an auxiliary memory; changing the security level value into a lost state when a main battery is separated without performing an ending process in the state where the security level value is in the protection; and operating in a lost mode.

In certain embodiments of the present disclosure, a method for protecting an electronic device includes: storing a security level value that represents a protection state in an auxiliary memory; changing the security level value into a lost state when it is detected that an input/output interface is connected in the state where the security level value is in the protection; and operating in a lost mode.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device according to embodiments of the present disclosure.

FIG. 2 illustrates a block diagram of an electronic device according to embodiments of the present disclosure.

FIG. 3 illustrates a method for protecting an electronic device according to embodiments of the present disclosure.

FIG. 4 illustrates a method for protecting an electronic device according to embodiments of the present disclosure.

### DETAILED DESCRIPTION

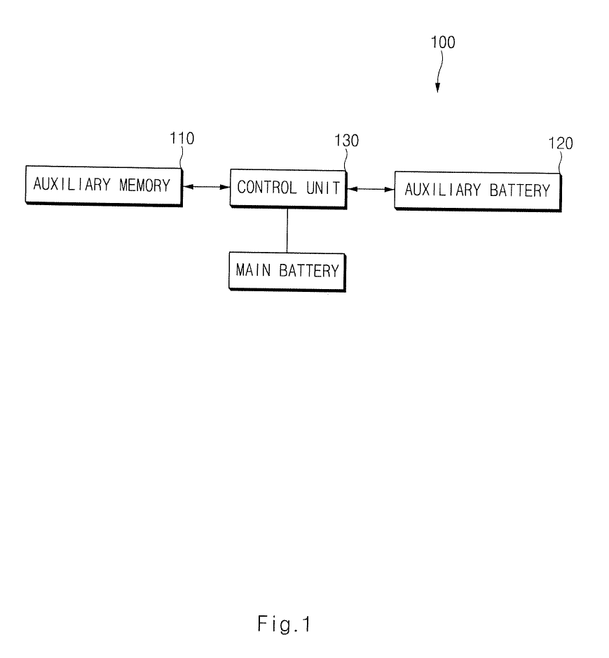

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure be implemented in any suitably arranged portable electronic device. Hereinafter, embodiments of the present disclosure will be described with reference to the accompanying drawings. Since the present disclosure may have diverse modified embodiments, embodiments are illustrated in the drawings and are described in the detailed description of the disclosure. However, this does not limit the present disclosure to specific embodiments and it should be understood that the present disclosure covers all the modifications and/or equivalents and replacements within the idea and technical scope of the present disclosure. Like reference numerals are used for referring to the same or similar elements in the description and drawings.

The meaning of ‘comprises’ and/or ‘comprising’ specifies a function, an operation, or an element does not exclude other functions, operations or elements. The meaning of ‘include’ or ‘comprise’ specifies a property, a fixed number, a step, an operation, an element, a component, or a combination thereof but does not exclude other properties, fixed numbers, steps, operations, elements, components, combinations thereof.

In various embodiments of the present disclosure, the expression “or” or “at least one of A or/and B” includes any and all combinations of words that are listed together with each other. For example, each of “A or B” or “at least one of A or/and B” include any words (A or B) or all words (A and B).

It will be understood that although the terms “first”, “second”, “firstly” or “secondarily” are used herein to describe various elements, these elements should not be limited by these terms. For example, the terms do not limit an order and/or importance of corresponding elements. The terms used in the description are merely used to distinguish equal or similar items in an ordinal manner. For example, all of a first user device and a second user device be user devices and also user devices different from each other. For example, a first element referred to as a first element in one embodiment can be referred to as a second element in another embodiment.

It will also be understood that when an element is referred to as being “connected to” or “engaged with” another element, it can be directly connected to the other element, or intervening elements also be present. It will also be understood that when an element is referred to as being “directly connected to” another element, there is no intervening elements.

In the following description, the technical terms are used only for explaining a specific embodiment while not limiting the present disclosure. The terms of a singular form include plural forms unless referred to the contrary.

Unless terms used in the present disclosure are defined differently, the terms may be construed as meaning known to those skilled in the art.

Terms such as terms that are generally used and have been in dictionaries should be construed as having meanings matched with contextual meanings in the art. In this description, unless defined clearly, terms are not ideally, excessively construed as formal meanings.

An electronic device according to various embodiments of the present disclosure includes a device having a loss/theft prevention function. For example, electronic device include at least one of smartphones, tablet personal computers (tablet PCs), mobile phones, video phones, e-book readers, desktop personal computers (desktop PCs), laptop personal computers (laptop PCs), netbook computers, personal digital assistants (PDAs), portable multimedia players (PMPs), MP3 players, mobile medical appliances, cameras, or wearable devices (e.g., head-mounted-devices (HMDs) such as electronic glasses, electronic clothes, electronic bracelets, electronic necklaces, electronic accessories, electronic tattoos, or smart watches).

According to some embodiments, the electronic device be a smart home appliance having a loss/theft prevention function. The smart home appliance, for example, the electronic device include at least one of televisions, digital video disk (DVD) players, audios, refrigerators, air conditioners, cleaners, ovens, microwave ovens, washing machines, air cleaners, set-top boxes, TV boxes (e.g., SAMSUNG HOMESYNC™, APPLE TV™, or GOGGLE TV™), game consoles, electronic dictionaries, electronic keys, camcorders, and electric photoalbum.

According to any embodiments, the electronic device include at least one of various medical appliances (e.g., magnetic resonance angiographies (MRAs), magnetic resonance imagings (MRIs), computed tomographies (CTs), tomographies, ultrasonic waves devices, etc.), navigation equipment, global positioning system (GPA) receivers, event data recorders (EDRs), flight data recorders (FDRs), automobile infotainment devices, electronic equipments for ship (e.g., navigation equipment for ship and gyrocompasses), avionics, security devices, head units for vehicle, industrial or household robots, automatic teller's machines (ATMs) of financial institution, and point of sales (POS) of store.

According to any embodiments, the electronic device include at least one of a portion of furniture having a lost/theft function or buildings/structures, electronic boards, electronic signature receiving devices, projectors, and all sorts of measuring tools (e.g., water, gas, radio gauges, and the like). The electronic device according to various embodiments of the present disclosure include combinations of at least one of the above-described various devices. Also, the electronic device according to various embodiments of the present disclosure includes a flexible device. Also, it is obvious to a skilled in the art that the electronic device according to various embodiments of the present disclosure is not limited to the above-described devices.

Hereinafter, an electronic device according to various embodiments of the present disclosure will be described with reference to the accompanying drawings. The term “a user” that is used in various embodiments can be referred to a person using the electronic device or a device (e.g., artificial intelligence electronic device) using the electronic device.

FIG. 1 illustrates a block diagram of an electronic device according to embodiments of the present disclosure.

Referring to FIG. 1, an electronic device 100 includes an auxiliary memory 110, an auxiliary battery 120, and a control unit 130. For another example, the electronic device 100 can be implemented as a portable electronic device. For example, the electronic device 100 can be implemented as a smartphone that is capable of providing a mobile communication service by using a mobile communication network such as 2G or 3G, LTE, LTE-A, and the like.

The auxiliary memory 110 stores a security level value. According to certain embodiments, the security level value can have three states. For example, the security level value can have a value that corresponds to a normal state, a protection state, or a lost state.

The electronic device 100 operates in a normal mode, a protection mode, or a lost mode according to the security level value stored in the auxiliary memory 110.

The normal mode means a mode in which the electronic device 100 operates in the normal state. For example, the normal mode represents a state in which a proper user (owner) of the electronic device normally and legally uses the electronic device. For example, in the normal mode, the electronic device 100 provides services such as calling, SMS service, application execution, and the like.

The protection mode means a mode in which the electronic device 100 operates in the same manner as the normal mode, but when a predetermined event occurs, the electronic device 100 is changed into the lost mode. For example, if a main battery of the electronic device 100 is lost/disconnected from the electronic device 100 without performing an ending process in the protection mode, the electronic device 100 enters into the lost mode.

The lost mode means a mode in which the electronic device 100 operates in a state where the electronic device 100 is lost. Thus, in the lost mode, services provided in the normal mode or the protection mode are blocked.

According to certain embodiments, the auxiliary memory 110 stores a security level value that represents the protection state or the lost state. According to certain embodiments, when the security level value of the auxiliary memory 110 is void (null), this represents the normal state.

According to certain embodiments, when the security level value of the auxiliary memory 110 is the normal state or the protection state, the security level value can be changed by the user. For example, the user may change the security level value stored in the auxiliary memory 110 from a value representing the normal state into a value representing the protection state. For another example, the user may change the security level value stored in the auxiliary memory 110 from the value representing the protection state into the value representing the normal state.

According to certain embodiments, the auxiliary memory 110 prohibits data writing when the security level value is changed into the lost state. For example, when the security level value is changed into the lost state, it is impossible to change the security level value.

According to certain embodiments, when the security level value is changed into the lost state, the security level value can be changed by an authentication process through a mobile carrier. For example, when the security level value is changed into the lost state, the security level value can be changed into the normal state or the protection state after the authentication process through the mobile carrier.

According to certain embodiments, the auxiliary memory 110 stores an international mobile equipment identity (IMEI) value. The auxiliary memory 110 stores a mobile station integrated service digital network number (MSISDN) value.

According to certain embodiments, the auxiliary memory 110 is implemented as an auxiliary subscriber identity module (SIM) card. For example, the auxiliary SIM card is a SIM card that is different from an external SIM card inserted into a mobile communication device such as a smartphone. According to certain embodiments, the auxiliary memory 110 is built in the electronic device 100, and cannot be separated from the electronic device 100.

The auxiliary memory 110 stores a value for sorting the auxiliary memory 110 from the external SIM card in 1 bit remaining as an reserved for future use (RFU) of a structure having an element file integrated circuit card identifier (ICCID) value in which an SIM card unique number is stored. The auxiliary memory 110 can use a general purpose input/output (GPIO) value so as to distinguish the auxiliary memory 110 from the external SIM card.

The auxiliary battery 120 can supply a power into the electronic device 100. According to certain embodiments, the auxiliary battery 120 is built in the electronic device 100, and cannot be separated from the electronic device 100. The auxiliary battery 120 is activated to supply a power when the main battery is separated without performing an ending process in the state where the security level value is in the protection or lost state.

According to an embodiment, the auxiliary battery 120 can be charged prior to the main battery. For example, when charging of the auxiliary battery 120 and the main battery starts in the state where they are discharged, the auxiliary battery 120 is charged first, and then the main battery can be charged after the auxiliary battery 120 is fully charged.

The control unit 130 controls an overall operation for performing the various embodiments of the present disclosure and following processes. The control unit 130 controls the electronic device 100 according to the security level value stored in the auxiliary memory 110.

The control unit 130 changes the security level value into the lost state when the main battery is separated without performing the ending process in the state where the security level value is in the protection state.

The control unit 130 controls the electronic device 100 to operate in the lost mode when the security level value stored in the auxiliary memory 110 is in the lost state. The control unit 130 reboots the electronic device 100 to operate in the lost mode when the security level value stored in the auxiliary memory 110 is changed into the lost state.

The control unit 130 blocks an event or control command that is inputted from the outside when the electronic device 100 operates in the lost mode (e.g., the security level value is changed into the lost state). For example, the control unit 130 blocks calling, data service, SMS reception, application execution, and the like in the lost mode. For another example, the control unit 130 blocks a control command inputted in the lost mode or prevents the control command from being inputted (e.g., touch input restriction on a touch screen). For further another example, the control unit 130 controls the electronic device 100 so that sending is prohibited in the lost mode except for mobile phone numbers set by the user.

An electronic device according to various embodiment of the present disclosure includes an auxiliary memory 110 storing one of security level value that represents a protection state or a lost state; an auxiliary battery 120 activated to supply a power when a main battery is separated without performing an ending process in the state where the security level value is in the protection or lost state; and a control unit 130 that changes the security level value into a value representing the lost state to operate in a lost mode when the main battery is separated without performing an ending process in the protection state.

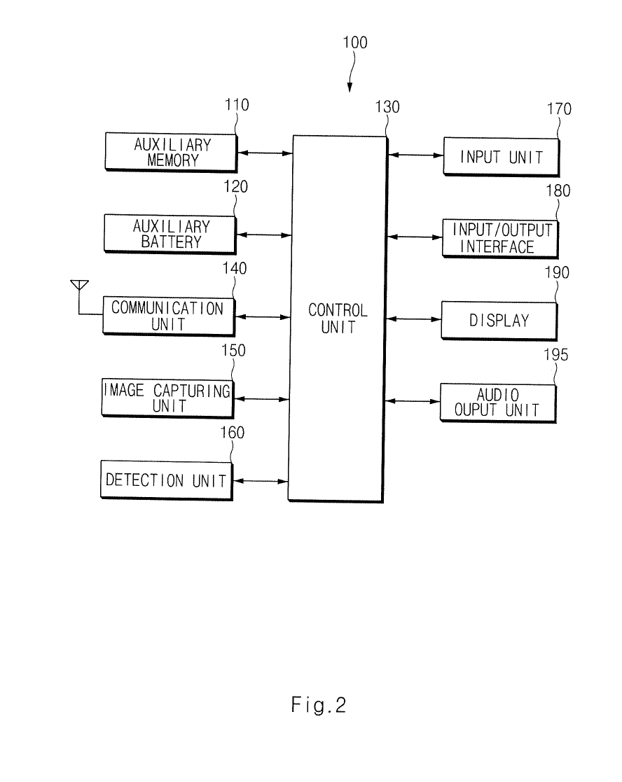

FIG. 2 illustrates a block diagram of an electronic device according to embodiments of the present disclosure.

Referring to FIG. 2, an electronic device 100 includes a communication unit 140, an image capturing unit 150, a detection unit 160, an input unit 170, an input/output interface 180, a display 190, and an audio output unit 195 as well as the auxiliary memory 110, the auxiliary battery 120, and the control unit 130.

Since the auxiliary memory 110, the auxiliary battery 120, and the control unit 130 of FIG. 2 respectively correspond to the auxiliary memory 110, the auxiliary battery 120, and the control unit 130 of FIG. 1, only different points there between may be described.

The communication unit 140 is connected to a mobile carrier server (not shown) to communicate with the mobile carrier server. The communication unit 140 communicates with the mobile carrier server through a mobile communication network such as 2G or 3G, LTE, LTE-A, and the like.

The communication unit 140 receives a message for deactivating an external SIM card from the mobile carrier server. The communication unit 140 receives a message for activating the auxiliary memory 110 from the mobile carrier server. The communication unit 140 receives a message for changing a security level value of the auxiliary memory 110 into a lost state from the mobile carrier server. For example, when a user of the electronic device 100 recognizes he has lost the electronic device 100, to inform a lost state of the electronic device 100 to the mobile carrier server, the mobile carrier server deactivates the external SIM card and transmits the message for changing the security level value of the auxiliary memory 110 into the lost state to the electronic device 100. When the electronic device 100 receives the message, the electronic device 100 deactivates the external SIM card to change the security level value of the auxiliary memory 110 into the lost state.

When the security level value stored in the auxiliary memory 110 is changed into the lost state, the communication unit 140 transmits position information of the electronic device 100 to the mobile carrier server. For example, when the security level value stored in the auxiliary memory 110 is changed into the lost state, the communication unit 140 continuously (or, at a preset time period) transmits the position information of the electronic device 100 to the mobile carrier server.

When the security level value stored in the auxiliary memory 110 is changed into the lost state, the communication unit 140 transmits identification information (or number) stored in the auxiliary memory 110 to the mobile carrier server. For example, the communication unit 140 transmits an IMEI value to the mobile carrier server. The communication unit 140 transmits an MSISDN value together with the IMEI value into the mobile carrier server.

When the security level value stored in the auxiliary memory 110 is changed to the lost state, the communication unit 140 transmits personal information of the user to the mobile carrier server. For example, the communication unit 140 transmits personal information such as contact numbers, pictures, moving pictures, and the like into the mobile carrier server. The personal information of the user can be deleted after being transmitted. Thus, even though the electronic device 100 is lost, the personal information of the user is protected.

When a face image is detected from images captured in the lost mode, the communication unit 140 transmits the detected face image to the mobile carrier server. Thus, a face of a person that acquires the lost electronic device may become known.

An image capturing unit 150 captures an image. In a normal or protection mode, the image capturing unit captures an image according to a user command. According to certain embodiments, the image capturing unit 150 continuously (or, at a preset time period) captures images of surrounding environments when the security level value stored in the auxiliary memory 110 is changed into the lost state.

The detection unit 160 detects a face image from images that are captured by the image capturing unit 150. The detection unit 160 detects the face image from the captured images by using a face detection algorithm. For example, the detection unit 160 detect the face image by using algorithms such as a neural network, ADABOOST, principal component analysis (PCA), support vector machine (SVM), and the like.

The input unit 170 receives a user command for controlling the electronic device 100. The input unit 170 receives a user command for changing the security level value of the auxiliary memory 110. For example, the input unit 170 receives a user command for changing the security level value from the normal state into the protection state. For another example, the input unit 170 receives a user command for changing the security level value from the protection state into the normal state.

The input unit 110 includes at least one of a touch screen or touch pad that operates by a touch input of the user, a mouse, and a motion recognition sensor that recognizes user's motion.

The input/output interface 180 connects the electronic device 100 to the other electronic device to transmit or receive data there between. The input/output interface 180 includes a USB interface, a D-SUB interface, an HDMI interface, or an optical interface.

The control unit 130 changes the security level value of the auxiliary memory 110 into the lost state when it is detected that the security level value stored in the auxiliary memory 110 is connected to the input/output interface 180 in the protection state.

The display 190 displays an image or object. According to certain embodiments, when the security level value stored in the auxiliary memory 110 is changed into the lost state, the display 190 displays an object that represents the lost state of the electronic device 100.

The audio output unit 195 outputs an audio signal. When the security level value stored in the auxiliary memory 110 is changed into the lost state, the audio output unit 195 outputs a warning sound for informing the lost mobile phone to the surroundings.

An electronic device 100 according to various embodiments of the present disclosure includes an auxiliary memory 110 storing one of security level values that represent a protection or lost state; an auxiliary battery 120 activated to supply a power when a main battery is separated without performing an ending process in the state where the security level value is in the protection or lost state; and a control unit that changes the security level value into the lost state to operate in a lost mode when it is detected that the security level value is connected to an input/output interface in the protection state.

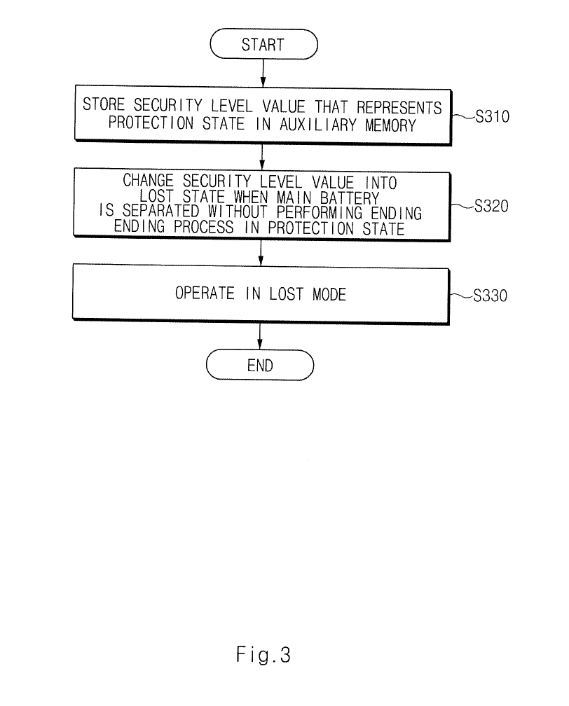

FIG. 3 illustrates a flowchart of a method for protecting an electronic device according to an embodiment of the present disclosure.

The flowchart illustrated in FIG. 3 can be constituted by time-series processes performed in the electronic device 100 of FIG. 1 or 2. Thus, although not described below, the technical contents related to the electronic device 100 of FIG. 1 or 2 also can be applied to the flowchart of FIG. 3.

Referring to FIG. 3, in operation 5310, an electronic device 100 stores a security level value that represents a protection state in an auxiliary memory 110. The auxiliary memory 110 stores the security level value. The security level value has three states. For example, the security level value has a value that corresponds to a normal state, a protection state, or a lost state. According to certain embodiments, the electronic device 100 operates in a normal mode, a protection mode, or a lost mode according to the security level value stored in the auxiliary memory 110.

The auxiliary memory 110 can be implemented as an auxiliary subscriber identity module (SIM) card. For example, the auxiliary SIM card can be an SIM card that is different from an external SIM card inserted into a mobile communication device such as a smartphone. According to an embodiment, the auxiliary memory 110 can be built in the electronic device 100, but not be separated from the electronic device 100.

In operation 5320, the electronic device 100 changes the security level value into the lost state when a main battery is separated without performing an ending process in the protection state.

In operation 5330, the electronic device 100 operates in the lost mode when the security level value is changed into the lost state. According to certain embodiments, the electronic device 100 can be rebooted to operate in the lost mode when the security level value stored in the auxiliary memory 110 is changed into the lost state.

The electronic device 100 blocks an event or control command that is inputted from the outside in the lost mode. For example, the electronic device 100 blocks calling, data service, SMS reception, application execution, and the like in the lost mode. For another example, the electronic device 100 blocks a control command inputted in the lost mode or prevent the control command from being inputted (e.g., touch input restriction on a touch screen). For further another example, the electronic device 100 can be controlled so that sending is prohibited in the lost mode except for mobile phone numbers set by the user.

According to an embodiment, the electronic device 100 prohibits data writing of the auxiliary memory 110 in the lost mode. For example, when the security level value is changed into the lost state, it can be impossible to change the security level value.

The security level value of the electronic device 100 can be changed in the lost mode by an authentication process through a mobile carrier. For example, when the security level value is changed into the lost state, the security level value can be changed into the normal state or the protection state after the authentication process through the mobile carrier.

The electronic device 100 transmits position information thereof to a mobile carrier server in the lost mode. For example, the electronic device 100 continuously (or at a preset time period) transmits the position information thereof to the mobile carrier server in the lost mode.

According to an embodiment, the electronic device 100 transmits an device identification number stored in the auxiliary memory 110 into the mobile carrier server in the lost mode. For example, the electronic device 100 transmits an IMEI value into the mobile carrier server. According to an embodiment, the electronic device 100 transmits an MSISDN value together with the IMEI value into the mobile carrier server.

According to an embodiment, the electronic device 100 transmits personal information of the user to the mobile carrier server in the lost mode. For example, the electronic device 100 transmits personal information such as contact numbers, pictures, moving pictures, and the like into the mobile carrier server. According to an embodiment, the electronic device 100 deletes the transmitted personal information from a storage unit (e.g., a storage) of the electronic device 100. Thus, even though the electronic device 100 is lost, the personal information of the user is protected.

According to an embodiment, the electronic device 100 continuously (or, at a preset time period) captures images of surrounding environments in the lost mode. Also, the electronic device 100 detects a face image from the captured images. When a face image is detected from the captured images, the electronic device 100 transmits the detected face image to the mobile carrier server.

According to an embodiment, the electronic device 100 displays an object that represents the lost electronic device in the lost mode. According to an embodiment, the electronic device 100 outputs a preset audio signal (e.g., a warning sound) in the lost mode.

According to an embodiment, the electronic device 100 can supply a power by using the auxiliary battery 130 when the main battery is separated without performing the ending process in the state where the security level value is in the protection or lost state.

A method for protecting the electronic device according to various embodiments of the present disclosure includes a process of storing a security level value that represents a protection state in an auxiliary memory, a process of changing the security level value into a lost state when a main battery is separated without performing an ending process in the state where the security level value is in a protection state, and a process of operating in a lost mode.

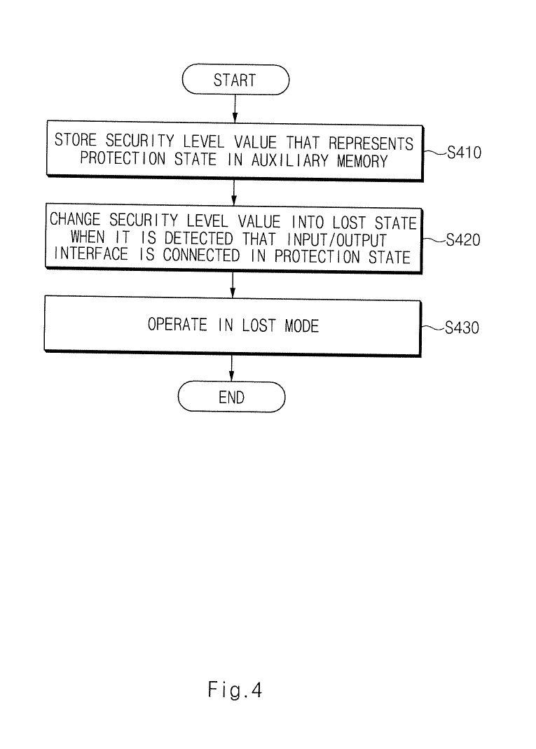

FIG. 4 illustrates a method for protecting an electronic device according to embodiments of the present disclosure.

The flowchart illustrated in FIG. 4 can be constituted by time-series processes that performed in the electronic device 100 of FIG. 1 or 2. Thus, although not described below, the technical contents related to the electronic device 100 of FIG. 1 or 2 also can be applied to the flowchart of FIG. 4.

Referring to FIG. 4, in operation 5410, a security level value that represents a protection state can be stored in an auxiliary memory 110. According to an embodiment, the auxiliary memory 110 stores the security level value. According to an embodiment, the security level value has three states. For example, the security level value can have a value that corresponds to a normal state, a protection state, or a lost state. According to an embodiment, the electronic device 100 operates in a normal mode, a protection mode, or a lost mode according to the security level value stored in the auxiliary memory 110.

According to an embodiment, the auxiliary memory 110 can be implemented as an auxiliary subscriber identity module (SIM) card. For example, the auxiliary SIM card can be a SIM card that is different from an external SIM card inserted into a mobile communication device such as a smartphone. The auxiliary memory 110 is built in the electronic device 100, and cannot be separated from the electronic device 100.

In operation 5420, the electronic device 100 changes the security level value into the lost state when it is detected that an input/output interface is connected in the state where the security level value is in the protection state.

In operation 5430, the electronic device 100 operates in the lost mode when the security level value is changed into the lost state. According to an embodiment, the electronic device 100 can be rebooted to operate in the lost mode when the security level value stored in the auxiliary memory 110 is changed into the lost state.

According to an embodiment, the electronic device 100 blocks an event or control command that is inputted from the outside in the lost mode. For example, the electronic device 100 blocks calling, data service, SMS reception, application execution, and the like in the lost mode. For another example, the electronic device 100 blocks a control command inputted in the lost mode or prevent the control command from being inputted (e.g., touch input restriction on a touch screen). For further another example, the electronic device 100 can be controlled so that sending is prohibited in the lost mode except for mobile phone numbers set by the user.

According to an embodiment, the electronic device 100 prohibits data writing of the auxiliary memory 110 in the lost mode. For example, when the security level value is changed into the lost state, it is impossible to change the security level value.

According to an embodiment, the security level value of the electronic device 100 can be changed in the lost mode by an authentication process through a mobile carrier. For example, when the security level value is changed into the lost state, the security level value can be changed into the normal state or the protection state after the authentication process through the mobile carrier.

According to an embodiment, the electronic device 100 transmits position information thereof to a mobile carrier server in the lost mode. For example, the electronic device 100 continuously (or at a preset time period) transmits the position information thereof to the mobile carrier server in the lost mode.

According to an embodiment, the electronic device 100 transmits a device identification number stored in the auxiliary memory 110 into the mobile carrier server in the lost mode. For example, the electronic device 100 transmits an IMEI value into the mobile carrier server. According to an embodiment, the electronic device 100 transmits an MSISDN value together with the IMEI value into the mobile carrier server.

According to an embodiment, the electronic device 100 transmits personal information of the user to the mobile carrier server in the lost mode. For example, the electronic device 100 transmits personal information such as contact numbers, pictures, moving pictures, and the like into the mobile carrier server. According to an embodiment, the electronic device 100 deletes the transmitted personal information. Thus, even though the electronic device 100 is lost, the personal information of the user can be protected.

According to an embodiment, the electronic device 100 continuously (or, at a preset time period) captures images of surrounding environments in the lost mode. Also, the electronic device 100 detects a face image from the captured images. When a face image is detected from the captured images, the electronic device 100 transmits the detected face image into the mobile carrier server.

According to an embodiment, the electronic device 100 displays an object that represents the lost electronic device in the lost mode. According to an embodiment, the electronic device 100 outputs a preset audio signal (e.g., a warning sound) in the lost mode.

According to an embodiment, the electronic device 100 can supply power by using the auxiliary battery 120 when the main battery is separated without performing the ending process in the state where the security level value is in the protection or lost state.

A method for protecting the electronic device according to various embodiments of the present disclosure include a process of storing a security level value that represents a protection state in an auxiliary memory, a process of changing the security level value into a lost state when it is detected that an input/output interface is connected in the state where the security level value is in a protection state, and a process of operating in a lost mode.

The method for protecting the electronic device according to the various embodiments of the present disclosure can be implemented as executable program. The program can be stored in various types of recording media to use.

Each of the above-described elements of the electronic device according to the various embodiments of the present disclosure can be constituted by at least one component, and the name of the corresponding component vary according to a kind of electronic device. The electronic device according to the various embodiments of the present disclosure include at least one of the above-described elements, wherein a portion of the elements can be omitted, or the other element can be added. Also, portions of the components of the electronic device according to the various embodiments of the present disclosure can be coupled to each other to form one entity, thereby performing the same function as the functions of the corresponding components that are not coupled to each other.

The term “module” used in the various embodiments of the present disclosure, for example, means a unit including one or more combinations of hardware, software, and firmware. For example, such a “module” can be interchangeably used as a unit, a logic, a logical block, a component, or a circuit. The “module” can be a smallest unit or a portion of the integrated component. The “module” can be a smallest unit or a portion of the component that performs at least one function. The “module” can be mechanically or electrically implemented. For example, the “module” according to the various embodiments of the present disclosure include at least one of an application specific integrated circuit (ASIC) ship, a field-programmable gate array (FPGA) and a programmable logic device, which perform any operations, that have been previously known or will be developed in future.

According to the various embodiments, at least portion of the devices (e.g., modules or their functions) or methods (e.g., operations) according to the various embodiments of the present disclosure can be, for example, implemented as instructions stored in computer-readable storage media having the form of a programming module. The instructions allow the at least one processor to perform functions corresponding to the instructions when the instructions are executed by the at least one processor. The computer-readable storage media can be, for example, the memory 530. At least one portion of the programming module can be, for example, implemented by the processor. At least one portion of the programming module include, for example, a module, program, routine, sets of instructions, or a process, which performs at least one function.

The computer readable recording medium includes magnetic media such as hard disk, floppy disk, or magnetic tape, optical media such as compact disc read only memory (CD-ROM) or digital versatile disc (DVD), magneto-optical media such as floptical disk, and a hardware device such as ROM. RAM, flash memory storing and executing program commands. Further, the program command includes a machine language code created by a complier and a high-level language code executable by a computer using an interpreter. The foregoing hardware device can be configured to be operated as at least one software module to perform an operation of the present disclosure.

The module or the programming module according to the various embodiments of the present disclosure includes at least one of the above-described elements, wherein a portion of the elements may be omitted, or the other component may be added. The operations performed by the module, the programming module, or other elements according to the various embodiments of the present disclosure can be executed by successive, paratactic, repeatable, or heuristic methods. Also, portions of the operations may be executed in different order or omitted, or other operations may be added.

According to various embodiments of the present disclosure, the electronic device enters into a protection mode by oneself even though the electronic device is not connected to the network. Therefore, the electronic device can be strengthened in security.

In addition, the downloading of the new binary into the lost electronic device can be prevented to prevent the lost electronic device from being illegally distributed.

Although the present disclosure has been described with an embodiment, various changes and modifications may be suggested to one skilled in the art. It is intended that the present disclosure encompass such changes and modifications as fall within the scope of the appended claims.

What is claimed is:

1. An electronic apparatus comprising:
an auxiliary memory configured to store security level value that represents one of a protection state or lost state;
an auxiliary battery configured to activate to supply a power when a main battery is separated without performing an ending process in the state where the security level value is in the protection or lost state; and
a control unit configured to change the security level value into the lost state, thereby allowing the electronic apparatus to operate in a lost mode, when the main battery is separated without performing the ending process in the state where the security level value is in the protection state.

2. The electronic apparatus according to claim 1, wherein the auxiliary memory comprises an auxiliary subscriber identity module (SIM) card that is built in the electronic apparatus.

3. The electronic apparatus according to claim 1, wherein the auxiliary memory is prohibited from writing data when the security level value represents the lost state.

4. The electronic apparatus according to claim 1, further comprising a communication unit configured to continuously transmit position information of the electronic apparatus to a mobile carrier server when the security level value is represents the lost state.

5. The electronic apparatus according to claim 1, further comprising a communication unit configured to transmit an apparatus identification number stored in the auxiliary memory into a mobile carrier server when the security level value represents the lost state.

6. The electronic apparatus according to claim 1, wherein the control unit is further configured to block an event or control command that is inputted from outside when the security level value represents the lost state.

7. The electronic apparatus according to claim 1, further comprising a communication unit configured to transmit personal information of a user to a mobile carrier server when the security level value the lost state,
wherein the control unit is further configured to delete personal information of the user after being transmitted.

8. The electronic apparatus according to claim 1, further comprising:
an image capturing unit configured to continuously captures images of surrounding environments when the security level value is changed to the lost state;
a detection unit configured to detect a face image from the captured images; and
a communication unit configured to transmit the detected face image to a mobile carrier server when the face image is detected from the captured images.

9. An electronic apparatus comprising:
an auxiliary memory configured to store one of a security level value that represents a protection state or a security level value that represents a lost state;
an auxiliary battery configured to activate to supply a power when a main battery is separated without performing an ending process in the state where the security level value is in the protection or lost state; and
a control unit configured to control the electronic apparatus to change the security level value into the lost state, thereby allowing the electronic apparatus to operate in a lost mode, in response to a determination that an input/output interface is connected without performing the ending process in the state where the security level value is in the protection state.

10. A method for protecting an electronic apparatus, the method comprising:
storing a security level value that represents a protection state in an auxiliary memory;
changing the security level value into a lost state when a main battery is separated without performing an ending process in the state where the security level value is in the protection; and
operating in a lost mode.

11. The method according to claim 10, further comprising, when the main battery is separated without performing the ending process in the state where the security level value is in the protection or lost state, supplying a power by using an auxiliary battery.

12. The method according to claim 10, wherein the auxiliary memory comprises an auxiliary subscriber identity module (SIM) card that is built in the electronic apparatus.

13. The method according to claim 10, wherein the operating-in-the-lost-mode comprises prohibiting data writing of the auxiliary memory when the security level value is changed into the lost state.

14. The method according to claim 10, wherein the operating-in-the-lost-mode comprises continuously transmitting position information of the electronic apparatus to a mobile carrier server.

15. The method according to claim 10, wherein the operating-in-the-lost-mode comprises transmitting an apparatus identification number stored in the auxiliary memory to a mobile carrier server.

16. The method according to claim 10, wherein the operating-in-a-lost-mode comprises blocking an event or control command that is inputted from the outside.

17. The method according to claim 10, wherein the operating-in-a-lost-mode comprises:
transmitting personal information of a user into a mobile carrier server; and
deleting the personal information of the user.

18. The method according to claim 10, wherein the operating-in-a-lost-mode comprises:
continuously capturing images of surrounding environments;
detecting a face image from the captured images; and
transmitting the detected face image into a mobile carrier server when the face image is detected from the captured images.

19. A method for protecting an electronic apparatus, the method comprising:
storing a security level value that represents a protection state in an auxiliary memory;
changing the security level value into a lost state in response to a determination that an input/output interface is connected in the state where the security level value is in the protection; and
operating in a lost mode.

20. A non-transitory computer-readable recording medium storing a computer program, the computer program comprising computer readable program code that, when executed by processing circuitry, causes the processing circuitry to perform:
store a security level value that represents a protection state in an auxiliary memory;
change the security level value into a lost state when a main battery is separated without performing an ending process in the state where the security level value is in the protection; and
operate in a lost mode.
